(19) United States
(12) Patent Application Publication
(10) Pub. No.: US 2014/0125306 A1
(43) Pub. Date: May 8, 2014

(54) Switching Regulator Control with Nonlinear Feed-Forward Correction

(71) Applicant: Infineon Technologies North America Corp., Milpitas, CA (US)

(72) Inventors: Amir Babazadeh, Irvine, CA (US); Benjamim Tang, Rancho Palos Verdes, CA (US)

(73) Assignee: INFINEON TECHNOLOGIES NORTH AMERICA CORP., Milpitas, CA (US)

(21) Appl. No.: 13/670,868

(22) Filed: Nov. 7, 2012

(51) Int. Cl. G05F 5/00

(52) U.S. Cl. CPC G05F 5/00
USPC 323/285

(57) ABSTRACT

A switching regulator includes a power stage and a controller. The power stage is operable to produce an output voltage. The controller is operable to set a duty cycle for the power stage based on feed-forward control so that the power stage produces the output voltage as a function of an input voltage and a reference voltage provided to the switching regulator. The controller is further operable to adjust the feed-forward control to counteract the effect of one or more nonlinearities of the switching regulator on the output voltage.

### TECHNICAL FIELD

The instant application relates to switching regulators, and more particularly to switching regulators with nonlinear feed-forward correction.

### BACKGROUND

Switching regulators should behave consistently and maintain high performance over a wide range of system variables, such as load current, input voltage, temperature, number of active phases, switching frequency, etc., in order to ensure proper load current and voltage regulation. Because of the nonlinear dynamics of switching regulators, conventional linear controllers, which are designed for nominal conditions, cannot maintain optimal performance over other conditions, requiring a nonlinear adjustment for the system. For example, conventional switching regulators employ feed-forward control, which is a technique for improving the dynamic regulation of switching regulators. Feed-forward control provides for fast dynamic regulation, i.e. rapidly corrects for an input-voltage or load-current perturbation without a wideband feedback loop. As such, the feed-forward dynamic behavior is independent from the compensation of the feedback loop. However, conventional feed-forward control does not compensate for the nonlinearities of a switching regulator.

### SUMMARY

According to the embodiments described herein, feed-forward control is employed in switching regulators to compensate for nonlinearities in the switching regulators. Doing so yields a consistent response over a wide range of system variables which may otherwise drive the system out of the linear operating region. The feed-forward control techniques described herein can be applied in both current mode and voltage mode control methods.

According to an embodiment of a method of controlling an power stage of a switching regulator, the method comprises: setting a duty cycle for the power stage using feed-forward control so that the power stage produces an output voltage based on an input voltage and a reference voltage provided to the switching regulator; and adjusting the feed-forward control to counteract the effect of one or more nonlinearities of the switching regulator on the output voltage.

According to an embodiment of a switching regulator, the switching regulator comprises a power stage and a controller. The power stage is operable to produce an output voltage. The controller is operable to set a duty cycle for the power stage based on feed-forward control so that the power stage produces the output voltage as a function of an input voltage and a reference voltage provided to the switching regulator. The controller is further operable to adjust the feed-forward control to counteract the effect of one or more nonlinearities of the switching regulator on the output voltage.

According to another embodiment of a switching regulator, the switching regulator comprises a power stage and a controller. The power stage is operable to produce an output voltage, and comprises a high-side transistor and a low-side transistor connected to an inductor. The controller is operable to increase a duty cycle for the power stage during a current cycle of the power stage if the high-side transistor turned on while the inductor current was negative during an immediately preceding cycle and the high-side transistor is expected to turn on while the inductor current is positive during the current cycle.

Those skilled in the art will recognize additional features and advantages upon reading the following detailed description, and upon viewing the accompanying drawings.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts. In the drawings:

FIG. 1 illustrates a block diagram of a switching regulator according to a first embodiment;

FIG. 2 illustrates a block diagram of a feed-forward adjustment block included in the switching regulator according to a first embodiment;

FIG. 3 illustrates a block diagram of a feed-forward adjustment block included in the switching regulator according to a second embodiment;

FIGS. 4A and 4B illustrate different source voltage waveforms for the switching regulator;

FIGS. 5A and 5B illustrate different source voltage waveform transitions for the switching regulator;

FIG. 6 illustrates a plot diagram showing the adverse effect of a particular inductor current condition on the source voltage pulse width;

FIG. 7 illustrates a block diagram of a feed-forward adjustment block included in the switching regulator according to a third embodiment;

FIG. 8 illustrates a block diagram of a feed-forward adjustment block included in the switching regulator according to a fourth embodiment; and

FIG. 9 illustrates a block diagram of the switching regulator according to a second embodiment.

### DETAILED DESCRIPTION

The embodiments described herein employ feed-forward control in a switching regulator which compensates for nonlinearities in the switching regulator. The feed-forward control techniques described herein can be applied to any switching regulator architecture, including: buck; boost; buck-boost; flyback; push-pull; half-bridge; full-bridge; and SEPIC (single-ended primary-inductor converter). A buck converter generates an output DC voltage that is lower than the input DC voltage. A boost converter generates an output voltage that is higher than the input. A buck-boost converter generates an output voltage opposite in polarity to the input. A flyback converter generates an output voltage that is less than or greater than the input, as well as multiple outputs. A push-pull converter is a two-transistor converter especially efficient at low input voltages. A half-bridge converter is a two-transistor converter used in many off-line applications. A full-bridge converter is a four-transistor converter usually used in off-line designs that can generate very high output power. A SEPIC is a type of DC-DC converter allowing the electrical voltage at its output to be greater than, less than, or equal to that at its input.

These switching regulator topologies transfer power from the input source to the load by alternatively energizing and de-energizing an inductor or transformer. These cycles are controlled by a set of switches or pass devices, and the voltage or current transfer is controlled by varying the duty cycle, or ratio of on-to-off time in these switches. The regulator controller monitors and maintains the output variables (voltage and current) by adjusting the duty cycle through feedback compensation. However, the target duty cycle can be estimated from the system variable and this value can be added so that the feedback compensation only needs to provide the difference, improving the dynamic response of the system.

For each type of switching regulator architecture, a consistent response over a wide range of system variables is realized by implementing feed-forward control in a way that compensates for the system nonlinearities. The feed-forward control is adjusted to counteract the effect of the system nonlinearities on the regulator output voltage, e.g. by scaling or adding/subtracting a bias value to a typical linear feed-forward control value. For example, in a buck-boost converter, the PWM (pulse width modulation) signal can be made proportional to the difference between the input voltage (Vin) and the output voltage (Vout) by integrating Vin−Vout with an integrator that is reset by a clock pulse. With the feed-forward control techniques described herein, the linear feed-forward control value is adjusted to compensate for one or more system nonlinearities so that the adjusted feed-forward control is input to the proper part of the integrator. The resulting PWM signal therefore is not unduly narrowed, which would otherwise occur without the nonlinearity compensation provided by the techniques described herein. An overly narrow PWM signal has a direct adverse effect on the output voltage of the switching regulator.

Described next are embodiments of the feed-forward control technique with nonlinearity compensation, explained in the context of a switched mode buck converter which employs voltage mode control. As such, the feed-forward control technique is based on input-voltage feed-forward. However, the feed-forward control techniques can equally be applied for current mode control methods where the feed-forward control technique is based on load-current feed-forward. Those skilled in the art will appreciate that the feed-forward control embodiments described herein can be readily applied to any suitable switching regulator architecture with minor modifications, if any. Such modifications are well within the capability of one of ordinary skill in the art, without requiring undue experimentation or further explanation.

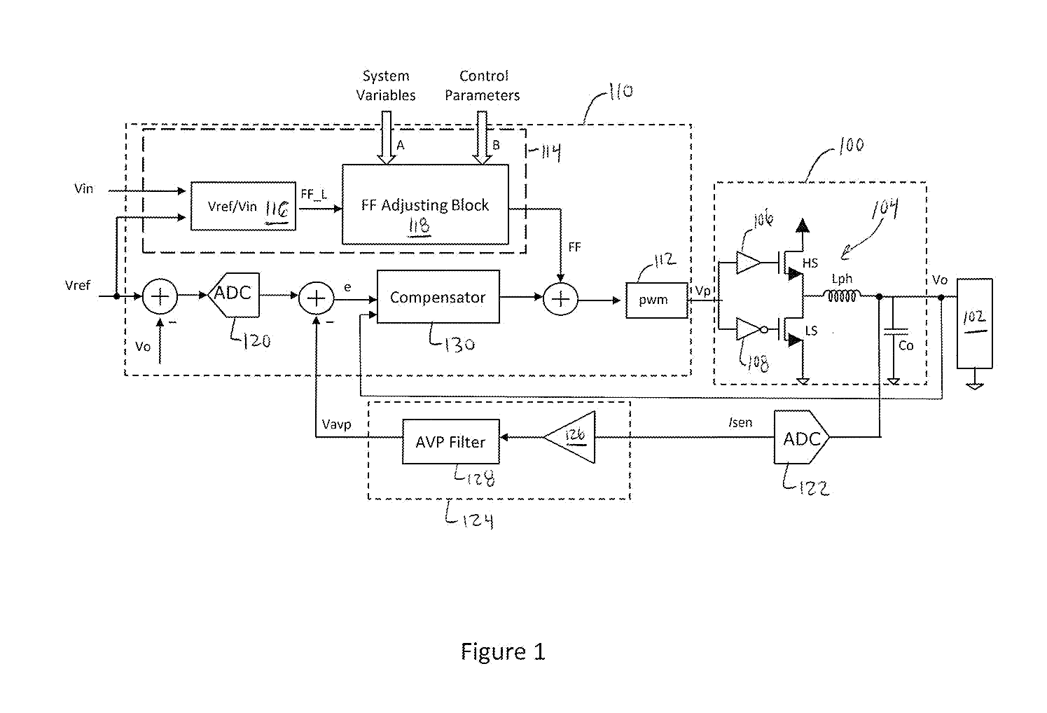

FIG. 1 illustrates a block diagram of an embodiment of a switched mode buck converter which includes an power stage 100 coupled to a load 102 such as a microprocessor, graphics processor, network processor, digital signal processor, etc. The power stage 100 has an input (Vp) and one or more phases 104. The power stage 100 supplies current to the load 102 by the one or more phases 104. Each phase 104 includes a high-side transistor (HS) and a low-side transistor (LS) driven by corresponding drivers 106, 108. Each output phase 104 provides current to the load 102 through an inductor (Lph). The amount of current provided by each output phase 104 depends on the switch state of the high-side and low-side transistors. An output capacitor (Co) is also coupled to the load 102, between the phase inductor and the load 102 as shown in FIG. 1. The output capacitor can be a single capacitor or a bank of capacitors in parallel.

Operation of the power stage 100 is controlled via PWM control implemented by a controller 110. The controller 110 includes a PWM control unit 112 that generates a PWM signal for each phase 104 of the power stage 100. The PWM signals are applied to the corresponding output phases 104, and each cycle of the PWM signals has an on-portion and an off-portion. The high-side transistor of the corresponding output phase 104 is switched on during the on-portion of each PWM cycle and the low-side transistor is switched off. Conversely, the low-side transistor is switched on during the off-portion of each PWM cycle and the high-side transistor is switched off.

The duty cycle (d) of the PWM signal determines how long the high-side and low-side transistors are switched on during each PWM cycle, respectively, and therefore the amount of current sourced by the corresponding output phase 104 to the load 102. The PWM signal(s) are generated based on the difference between a reference voltage (Vref) provided to the switched mode buck converter and the output voltage (Vo), and also based on the input voltage (Vin) provided to the converter. In some embodiments, the reference voltage corresponds to a voltage identification (VID) associated with the load 102. The VID determines the regulator set-point i.e. the target voltage of the regulator when the load current is zero.

The controller 110 further includes a feed-forward control unit 114. The feed-forward control unit 114 has a linear feed-forward block 116 and a feed-forward (FF) adjustment block 118. The linear feed-forward block 116 generates linear feed-forward information (FF_L) which reflects the ratio of the reference voltage to the input voltage, i.e. Vref/Vin. The feed-forward adjustment block 118 adjusts this linear feed-forward control value (FF_L) to counteract the effect of one or more nonlinearities of the switching regulator on the output voltage. For example, the feed-forward adjustment block 118 can scale the linear feed-forward information or add/subtract a bias term to the linear feed-forward information to yield adjusted feed-forward information (FF) which is used by the controller 110 in setting the duty cycle of the PWM control signals. The feed-forward adjustment block 118 can be implemented as a look-up table accessible by the controller 110, or as a nonlinear formula implemented digitally in the controller 110 so that the controller 110 can be programmed to counteract a nonlinearity of the switching regulator.

In each case, the feed-forward adjustment block 118 evaluates one or more monitored system variables (A) such as power state of the switching regulator, phase current of the output stage, output voltage, input voltage, number of active phases of the output stage, operating temperature of the switching regulator, etc. The feed-forward adjustment block 118 adjusts the linear feed-forward information (FF_L) according to the monitored system variables based on programmed control parameters (B). The control parameters provide high order polynomial or piecewise linear correction to compensate for the nonlinear dependence on some of the system variables. The feed-forward control information (FF) used in setting the duty cycle of the PWM control signals thus accounts for the effect of system nonlinearities on the output voltage, ensuring a consistent output voltage response over a wide range of system variables.

One or more of the control parameters (B) can be programmable. The control parameters (B) can be threshold values and/or control settings. For example, if the feed-forward adjustment block 118 represents a piecewise linear system, the control parameters can be threshold values and also the corresponding gains for scaling the slopes. However, if the feed-forward adjustment block 118 represents a high order polynomial for compensating nonlinearities, the control parameters B can be parameter settings (e.g. polynomial coefficients).

In addition to the feed-forward control unit 110, the switching regulator also includes an ADC (analog-to-digital converter) 120 for sampling the difference between the reference voltage and the output voltage (Vo) and another ADC 122 for sampling the current (Isen) flowing in the inductor of each phase 104 of the power stage 100. The switching regulator further includes an adaptive voltage positing (AVP) unit 124 that generates an offset (Vavp) to the reference voltage (Vref) by an amount proportional to the sensed inductor current for each output phase 104. The AVP unit 124 includes an amplifier 126 and an AVP filter 128 in FIG. 1. In general, the controller 110 can implement any conventional AVP loop. AVP in the context of switching regulators is well known, and therefore no further explanation is given in this regard. The offset (Vavp) generated by the AVP unit 124 constitutes an error signal (e) which is input to a compensator 130 of the controller 110. In one embodiment, the compensator 130 is a PID (proportional-integral-derivative) filter which implements a compensator transfer function with the error voltage (e) as an input and duty cycle as the output.

The duty cycle output is adjusted based on the feed-forward control information (FF) provided by the feed-forward control unit 114. For example, the duty cycle can be adjusted by pulse widening or narrowing. As such, the duty cycle of each PWM signal provided to the power stage 100 of the switching regulator is based on the offset (Vavp) generated by the AVP unit 124 and the adjusted feed-forward control information (FF) provided by the feed-forward control unit 114. The feed-forward control unit 114 rapidly corrects for input-voltage or load-current perturbations without using a wideband feedback loop, and is therefore independent from the compensation of the feedback loop. The feed-forward control unit 114 counteracts the effects of system nonlinearities on the output voltage, enhancing the bandwidth and robustness of the switching regulator.

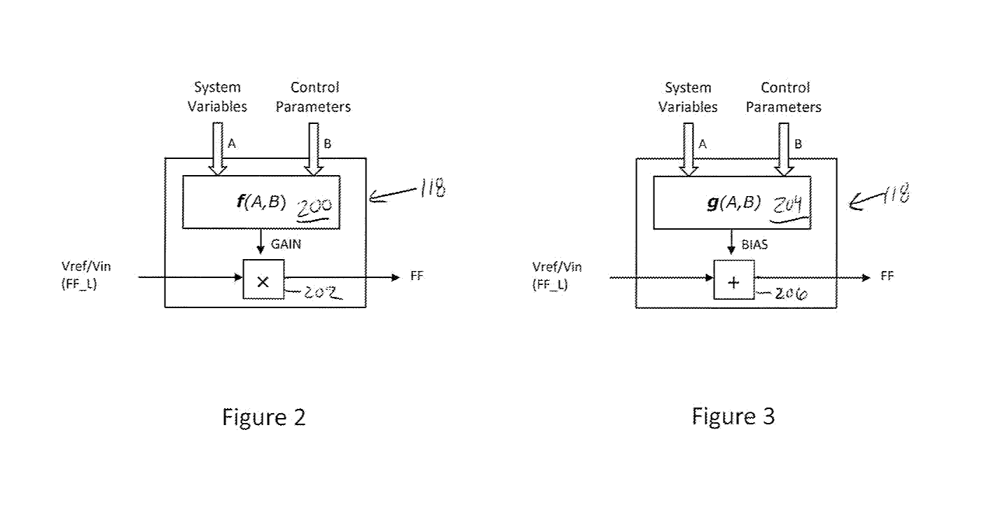

FIG. 2 illustrates one embodiment of the feed-forward adjustment block 118 included in or associated with the feed-forward control unit 114. According to this embodiment, the feed-forward adjustment block 118 implements a compensation function (f) (block 200) which operates on the system variables (A) and the corresponding control parameters (B) input to the feed-forward adjustment block 118. In one embodiment, the compensation function generates a gain term (GAIN) responsive to a nonlinearity of the switching regulator, e.g. when one of the monitored system variables violates its corresponding threshold. For example, the compensation function sets GAIN>1 when the operating temperature of the switching regulator increases by 20° C. and sets GAIN even higher when the operating temperature increase is even larger. Equivalent gain settings can be set for the sensed inductor current (Isen), power state of the switching regulator, Vout, Vin, number of active phases 104 of the power stage 100, etc.

The gain values used by the feed-forward control unit 114 can be predetermined, determinable by the controller 110, or some combination of both, i.e. some gain values can be predetermined and others can be determinable. In one embodiment, the controller 110 sweeps the load current supplied by the power stage 100 to identify a control parameter at which a nonlinearity of the switching regulator causes the bandwidth of the switching regulator to degrade by more than a target amount. The controller 100 sets a gain value for that system variable so that the effect of the nonlinearity is minimized. The feed-forward adjustment block 118 adjusts the feed-forward control (FF) based on the gain value determined by the controller 110 when the load current drops below the control parameter during operation of the switching regulator.

In general, the feed-forward adjustment block 118 multiplies (block 202) the linear feed-forward control information (FF_L) calculated based on Vref/Vin with the gain term (predetermined or otherwise) to scale the linear feed-forward control information (FF_L). No scaling is performed (i.e. GAIN=1) when none of the control parameters are violated, i.e. there is no detected system nonlinearity. The compensation function (f) can be linear or nonlinear.

FIG. 3 illustrates another embodiment of the feed-forward adjustment block 118 included in or associated with the feed-forward control unit 114. According to this embodiment, the feed-forward adjustment block 118 implements a compensation function (g) (block 204) which generates a bias term (BIAS) responsive to a nonlinearity of the switching regulator, e.g. when one of the monitored system variables violates its corresponding threshold. The bias term is calculated as a function of the one or more monitored system variables and the corresponding control parameter for each monitored system variable. The feed-forward adjustment block 118 adds or subtracts (block 206) the bias term from the linear feed-forward control information (FF_L) to adjust the linear feed-forward control information (FF_L). No adjustment is performed (i.e. BIAS=0) when none of the control parameters are violated i.e. there is no detected system nonlinearity. The compensation function (g) can be linear or nonlinear.

A consistent response over a wide range of system variables can be realized by implementing feed-forward control with nonlinearity compensation. For example, the nonlinear feed-forward control approach described herein can be used to maintain the output voltage response consistent over a wide range of load changes. In other words, the drop in measured bandwidth typically expected can be minimized at low currents by implementing feed-forward control with nonlinearity compensation. The bandwidth in switching regulators can change as a function of load current, causing the voltage response to be inconsistent in some ranges. Voltage response inconsistency tends to occur for transients in low current ranges, and subsides when the load current increases.

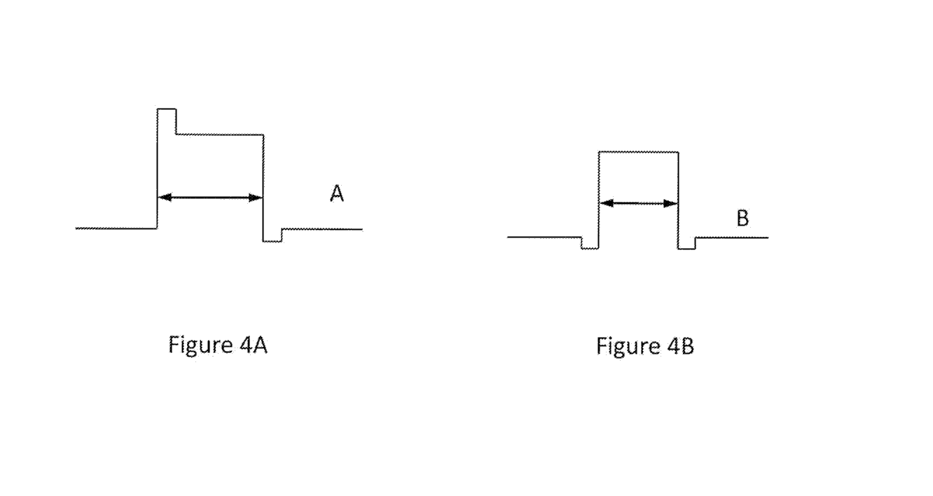

FIGS. 4A and 4B shows two kinds of switch node waveforms. The switch node waveforms correspond to the source voltage of the switching regulator. Waveform ‘A’ occurs when the high-side transistor of the corresponding output phase 104 turns on while the inductor current is negative, i.e. a small part of the inductor ripple current is negative as shown in FIG. 4A. Spikes occur in the switch node waveform during the dead-times, i.e. when both transistors are switched off. For example, waveform ‘A’ has a positive spike at the beginning of the cycle and a negative spike at the end of the cycle. Waveform ‘B’ occurs when the high-side transistor of the corresponding output phase 104 turns on while the inductor current is positive and above a threshold as shown in FIG. 4B. Waveform ‘B’ has a negative spike at the beginning and end of the cycle. The body diode of the high-side transistor turns on during the positive spikes (i.e. the first spike of waveform ‘A’) to provide a path for the excessive current during these dead-times, and the body diode of the low-side transistor turns on during the negative spikes (i.e. the second spike of waveform ‘A’ and both spikes of waveform ‘B’) to provide a current path during these other dead-times.

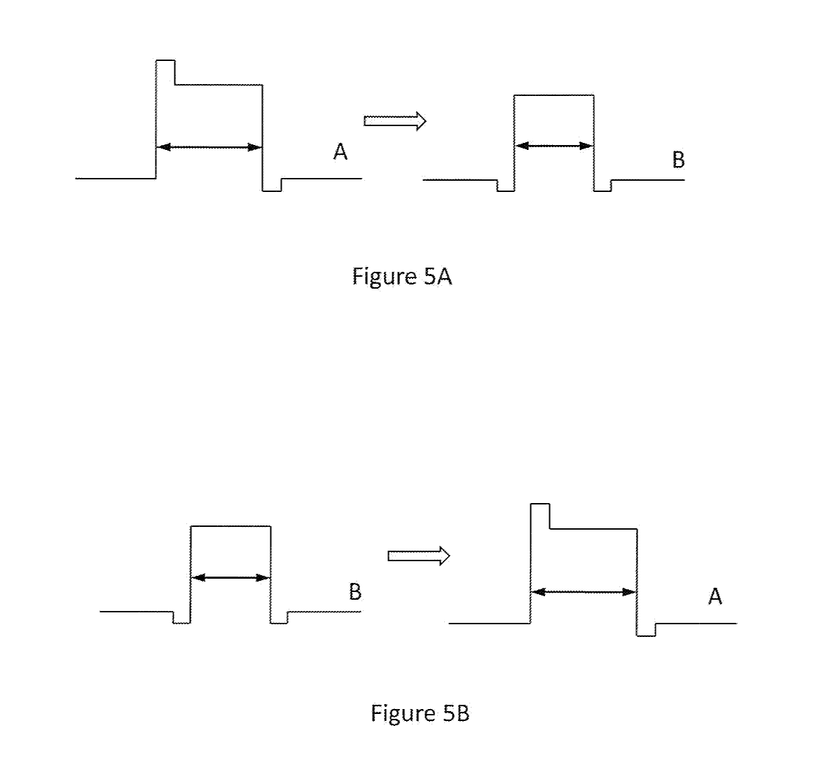

FIG. 5A shows such a succession of waveforms, where waveform ‘A’ in one cycle is immediately followed by waveform ‘B’ in the next cycle. If a transient occurs in A or B, the bandwidth remains consistent. However, the bandwidth is reduced and the transient response slows when a transient occurs from A to B. FIG. 5B shows the opposite succession of waveforms i.e. waveform ‘B’ in one cycle immediately followed by waveform ‘A’ in the next cycle. The transition from A to B (FIG. 5A) occurs when the current increases and the negative part of ripple moves to the positive side, and the transition from B to A (FIG. 5B) occurs when the low part of the current ripple moves from positive to negative.

All compensators need a high DC gain to minimize the steady state error. In PID (proportional-integral-derivative) controllers, the integrator term controls the steady state voltage response. After any transient, the integrator part of the PID implemented by the compensator 130 settles at a value which is determined by the error in the feed-forward term. That is, adjusting the feed-forward gain impacts the settling value of the integrator in the system, and the feed-forward gain can be set such that the integrator settles at zero for instance. For transitions from A to A or B to B, due to the consistency of the pulses, the steady-state value of the integrator does not change remarkably, so no additional tails or slow response is observed if the system is designed properly. However for transitions from A to B or B to A, the pulses are not consistent and there is a sudden change in the pulse width. This causes the integrator to settle at a different value than desired, and so the voltage response becomes slow with additional overshoot (undershoot) and long settling time. The embodiments described herein modify and adjust the feed-forward term such that the integrator after the transitions from A to B or B to A does not need to work hard toward its final value and settles at a value which is close to that of before the transition.

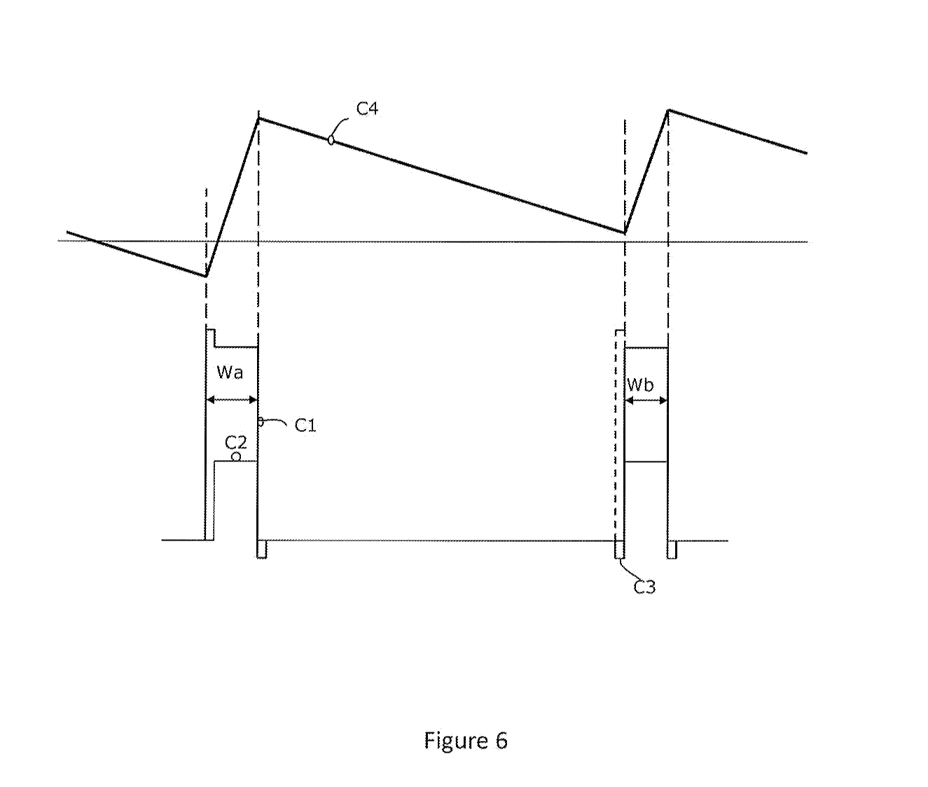

FIG. 6 shows the adverse effect on the source voltage (curve C1) which results when waveform ‘A’ in one cycle is immediately followed by waveform ‘B’ in the next cycle. Also plotted in FIG. 6 are the high-side transistor PWM control signal (curve C2), the dead time (curve C3) and the inductor current (curve C4). Waveform ‘A’ has a width Wa, and is followed by waveform ‘B’ which has a smaller width Wb. The reduced width Wb results from the inductor current being negative at the beginning of the first cycle (waveform ‘A’), but being positive at the beginning of the immediately following cycle (waveform ‘B’). Such a change in the inductor current causes a corresponding reduction in the pulse width of the source voltage, which in turn slows the system response.

The feed-forward control techniques described herein can counteract this adverse effect caused by a negative-to-positive transition in the inductor current from one cycle to the next cycle. For example, the feed-forward control unit 114 included in or associated with the regulator controller 110 can increase the duty cycle for the power stage 100 to prevent narrowing of the source voltage pulse width during such inductor current conditions. If the high-side transistor turned on while the inductor current was negative during the immediately preceding cycle and the high-side transistor is expected to turn on while the inductor current is positive during the current cycle as shown in FIG. 6, the feed-forward control unit 114 extends the width of the source voltage pulse as previously described herein, e.g. by scaling or adding/subtracting a bias term from the linear feed-forward control information (FF_L) which in turn widens the source voltage pulse width. This way, the output voltage response remains consistent over a wide range of load changes.

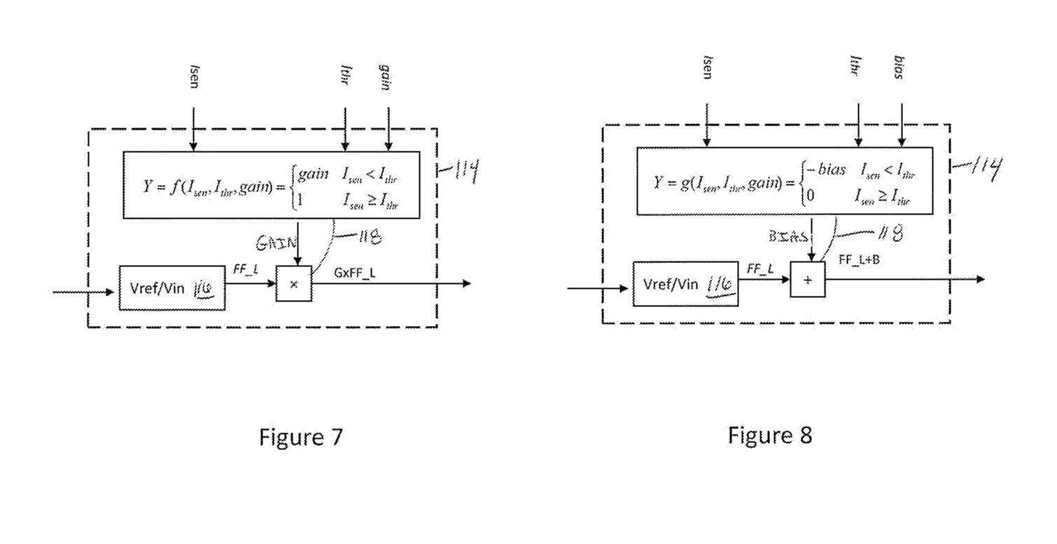

FIG. 7 illustrates another embodiment of the feed-forward control unit 114 included in or associated with the regulator controller 110. According to this embodiment, the compensation function (f) implemented by the feed-forward adjustment block 118 operates on the sensed inductor current (Isen) of each output phase 104 and the corresponding current control parameters (Ithr). If Isen<Ithr, the gain (GAIN) is set to a value (gain) corresponding to the amount by which Isen is less than Ithr. Otherwise, GAIN=1. The linear feed-forward control information (FF_L) is scaled by the gain as given by GAIN×FF_L to generate the adjusted feed-forward control information used in setting the duty cycle of the power stage 100, i.e. the duty cycle of the PWM control signal(s) driving the output phases 104 of the switched mode buck converter shown in FIG. 1.

FIG. 8 illustrates yet another embodiment of the feed-forward control unit 114 included in or associated with the regulator controller 110. According to this embodiment, the compensation function (g) implemented by the feed-forward adjustment block 118 operates on the sensed inductor current (Isen) of each output phase 104 and the corresponding current control parameters (Ithr). If Isen<Ithr, the bias (BIAS) is set to a value (−bias) corresponding to the amount by which Isen is less than lthr. Otherwise, BIAS=0. The bias value is added to or subtracted from the linear feed-forward control information (FF_L) as given by FF_L+BIAS to generate the adjusted feed-forward control information used in setting the duty cycle of the power stage 100.

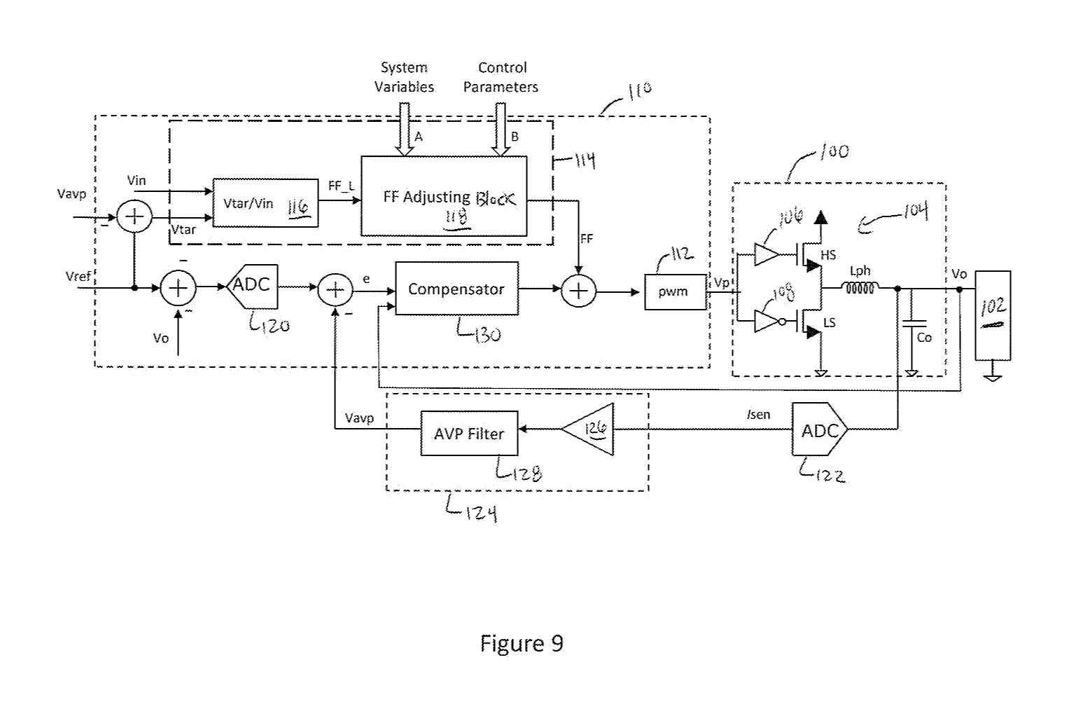

FIG. 9 illustrates a block diagram of another embodiment of the switched mode buck converter. The embodiment shown in FIG. 9 is similar to the embodiment shown in FIG. 1. However, the offset (Vavp) generated by the AVP unit 124 is subtracted from the reference voltage (Vref) to generate a target voltage (Vtar). The linear feed-forward block 116 included in or associated with the feed-forward control unit 114 generates the linear feed-forward information (FF_L) as the ratio of the target voltage to the input voltage i.e. Vtar/Vin. The feed-forward adjustment block 118 adjusts this linear feed-forward control value (FF_L) to counteract the effect of one or more nonlinearities of the switching regulator on the output voltage as previously described herein.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method of controlling a power stage of a switching regulator, the method comprising:
setting a duty cycle for the power stage using feed-forward control so that the power stage produces an output voltage based on an input voltage and a reference voltage provided to the switching regulator; and
adjusting the feed-forward control to counteract the effect of one or more nonlinearities of the switching regulator on the output voltage.

2. The method according to claim 1, wherein adjusting the feed-forward control comprises:
calculating a feed-forward control value based on the input voltage and the reference voltage; and
scaling the feed-forward control value responsive to a nonlinearity of the switching regulator.

3. The method according to claim 2, wherein scaling the feed-forward control value responsive to a nonlinearity of the switching regulator comprises:
calculating a gain term as a function of one or more system variables of the switching regulator and a corresponding control parameter for each system variable; and
multiplying the feed-forward control value by the gain term.

4. The method according to claim 1, wherein adjusting the feed-forward control comprises:
calculating a feed-forward control value based on the input voltage and the reference voltage; and
adding or subtracting a bias term to the feed-forward control value responsive to a nonlinearity of the switching regulator.

5. The method according to claim 4, further comprising calculating the bias gain term as a function of one or more system variables of the switching regulator and a corresponding control parameter for each system variable.

6. The method according to claim 1, wherein the feed-forward control is adjusted responsive to a system variable of the switching regulator violating a control parameter.

7. The method according to claim 6, wherein the feed-forward control adjustment is based on one or more programmable control parameters.

8. The method according to claim 6, wherein the system variable corresponds to a power state of the switching regulator, a phase current of the power stage, the output voltage, the input voltage, a number of active phases of the power stage, or operating temperature of the switching regulator.

9. The method according to claim 1, wherein the power stage comprises a high-side transistor and a low-side transistor connected to an inductor, and wherein adjusting the feed-forward control comprises increasing the duty cycle for the power stage during a current cycle of the power stage if the high-side transistor turned on while the inductor current was negative during an immediately preceding cycle and the high-side transistor is expected to turn on while the inductor current is positive during the current cycle.

10. A switching regulator, comprising:
an power stage operable to produce an output voltage; and
a controller operable to set a duty cycle for the power stage based on feed-forward control so that the power stage produces the output voltage as a function of an input voltage and a reference voltage provided to the switching regulator, and adjust the feed-forward control to counteract the effect of one or more nonlinearities of the switching regulator on the output voltage.

11. The switching regulator according to claim 10, wherein the controller is operable to calculate a feed-forward control value based on the input voltage and the reference voltage, and scale the feed-forward control value responsive to a nonlinearity of the switching regulator.

12. The switching regulator according to claim 11, wherein the controller is operable to calculate a gain term as a function of one or more system variables of the switching regulator and a corresponding control parameter for each system variable, and multiply the feed-forward control value by the gain term.

13. The switching regulator according to claim 10, wherein the controller is operable to calculate a feed-forward control value based on the input voltage and the reference voltage, and add or subtract a bias term to the feed-forward control value responsive to a nonlinearity of the switching regulator.

14. The switching regulator according to claim 13, wherein the controller is operable to calculate the bias gain term as a function of one or more system variables of the switching regulator and a corresponding control parameter for each system variable.

15. The switching regulator according to claim 10, wherein the controller is operable to adjust the feed-forward control responsive to a system variable of the switching regulator violating a control parameter.

16. The switching regulator according to claim 15, wherein the feed-forward control adjustment is based on one or more programmable control parameters.

17. The switching regulator according to claim 15, wherein the system variable corresponds to a power state of the switching regulator, a phase current of the power stage, the output voltage, the input voltage, a number of active phases of the power stage, or operating temperature of the switching regulator.

18. The switching regulator according to claim 10, wherein the controller is operable to adjust the feed-forward control responsive to a nonlinearity of the switching regulator based on information obtained from a look-up table and associated with the nonlinearity.

19. The switching regulator according to claim 10, wherein the controller is operable to be programmed to adjust the feed-forward control to counteract a nonlinearity of the switching regulator.

20. The switching regulator according to claim 19, wherein the controller is operable to:
sweep a load current supplied by the power stage to identify a control parameter at which a nonlinearity of the switching regulator causes a bandwidth of the switching regulator to degrade by more than a target amount;
set a gain value so that the effect of the nonlinearity is minimized; and
adjust the feed-forward control based on the gain value when the load current drops below the control parameter during operation of the switching regulator.

21. A switching regulator, comprising:
an power stage operable to produce an output voltage, the power stage comprising a high-side transistor and a low-side transistor connected to an inductor; and
a controller operable to increase a duty cycle for the power stage during a current cycle of the power stage if the high-side transistor turned on while the inductor current was negative during an immediately preceding cycle and the high-side transistor is expected to turn on while the inductor current is positive during the current cycle.
